(19) United States
(12) Patent Application Publication
(10) Pub. No.: US 2005/0076564 A1
(43) Pub. Date: Apr. 14, 2005

(54) Agricultural foam growing material

(76) Inventor: Wayne Castleberry, Richmond, VA (US)

Correspondence Address: John S. Hale;GIPPLE & HALE, 6665-A Old Dominion Drive, McLean, VA, 22101, US

(21) Appl. No.: 10/670,531

(22) Filed: Sep. 26, 2003

(51) Int. Cl. A01G 31/00

(52) U.S. Cl. 47/59 S

(57) ABSTRACT

A horticultural growing medium comprises a diphenylmethane diisocyanate polymer foam material with a cation exchange capacity ranging from about 1.0 to about 1.5 and at least 50% by volume being pores ranging in size from between 10 and 200 microns.

### CROSS-REFERENCE TO RELATED APPLICATIONS

This is no related applications.

### TECHNICAL FIELD OF THE INVENTION

The present invention relates generally to the use of urethane foams in grower applications. More particularly, this invention relates to an organic polyisocyanate foam material using one or more of crude, polymeric, 4, 4′-, 2,4′- and 2,2′-diphenylmethane diisocyanates with no filler material and having a low cation exchange capacity.

### BACKGROUND OF THE INVENTION

In the area of horticulture, individual containers for seed germination and seedling growth are well known. Seeds may be germinated in small individual containers or subdivided trays containing earth, peat, vermiculite, or other potting material, and grown under controlled greenhouse conditions for quick initial growth. Seedlings are typically transplanted to larger containers or to the field on reaching a sufficient stage of maturity. The filling of such seedling containers with potting material can be a time consuming process and using of such containers is relatively expensive and less desirable than direct planting in the field in various applications. When a seedling is transplanted, damage to the root system may occur, for example, if the loose potting material falls away from the roots and pulls some of the roots away from the seedling. Root damage occurring during transplantation is a particular problem when seedlings are mechanically transplanted.

The use of a cohesive potting material in such applications has been attempted to overcome such disadvantages. In this regard, polyurethane foam has been used as a substrate for plant growth. While the use of polyurethane foam decreased the likelihood of damage to the root system of seedlings grown in such a medium, polyurethane foam alone cannot deliver necessary nutrients to the seedling. While some nutrients can be incorporated into a polyurethane foam, others may impair the structural properties of the foam.

Another prior art device which overcame some of the disadvantages of both the use of non-cohesive growing material and polyurethane foam plant growth medium combines foam flakes and nutritives with a binding agent such as polyurethane. This medium provided good hydration to the growing plants due to the water capacity of the foam flakes. The structure of this material also provided for good aeration of the root system of seedlings planted in the material. The medium is introduced into a container and subjected to pressure and steam to induce reaction of the polyurethane. It has been noted that such treatment suffers from the disadvantage that steam treatment sterilizes the medium of microbes, some of which may be beneficial for plant growth thus requiring microbes to be separately added to the medium after the binder has set.

Another known method of making a composite plant growth medium also utilized a pre-polymer such as polyurethane to form a soil composite material. In this method, a slurry of soil material and water is brought into contact with a water-reactive pre-polymer, initiating a reaction between the pre-polymer and the water. The mixture is quickly dispensed into receptacles during this initial reaction time.

Another composition mixes a urethane prepolymer, preferably tolylene diisocyanate with aggregate material and fertilizers, herbicides, or related supplements, followed by mixing with sufficient water to form a pourable slurry. The pourable slurry is then deposited in a mold to form a shaped aggregate. One disadvantage is that foam composites formed from a slurry have a water content which can allow the growth of molds or other microbes which may be harmful to the growing plant or to the structural soundness of the composite, or may simply be esthetically unpleasant to consumers.

Furthermore, foam composites having a significant water content will naturally be heavier than similar products without a high water content, creating greater cost and difficulty in manufacturing and shipping. The use of tolylene diisocyanate can cause health problems for individuals who are sensitive to this compound. Previous polyurethane foam compositions also suffered from the disadvantage that these polyurethanes were not hydrophilic, necessitating the addition of wetting agents to permit adequate water penetration into the foam composite.

U.S. Pat. No. 6,479,433 issued Nov. 12, 2002 is directed toward a horticultural growing medium using a polyisocyantate-polyol-based polymer and at least one filler material. The filler materials may be earth, sand, pear moss, saw dust, manure, compost limestone, coir, ground foam, gypsum, peat, ground scrap foam, or other materials and is not formed from a prepolymer slurry containing water and aggregate material.

U.S. Pat. No. 4,193,909 is directed toward a flower pot made from a polyurethane resin, sand, silane compounds, iron oxide and powdered thermoplastic resins. The cured pots are subsequently baked at a temperature sufficient to fuse the thermoplastic resin to provide a pot having air permeability but resistance to the permeation of water.

Therefore, there is a need for a hydrophilic polyurethane composition having a low cation exchange capacity to prevent buildup of salts and for a foam which does not incorporate filler materials such as peat, ground scrap foam, or other filler materials, and is not formed from a prepolymer slurry containing water and filler material.

### SUMMARY OF THE INVENTION

A horticultural growing medium formed of a sterile diphenylmethane diisocyanate (MDI) foam material with a cation exchange capacity (C.E.C.) ranging from about 1.0 to about 1.5 milliequivalents (meg)/100 g. and being capable of supporting plant growth. The foam material has at least 50% of its pores ranging in size from 10 to 200 microns and is substantially free of microbes.

It is an object of the present invention to provide a hydrophilic polyurethane foam for horticultural use in seedlings and plant prorogation.

It is another object of the invention to take a growing medium cast into preformed sheets and cut the same into blocks which are then placed in containers such as trays or other molds or use the preformed sheets themselves. The horticultural growing medium is placed into a container prior to being contacted with water.

It is an object of the invention to provide a horticultural growing medium having a low cation exchange reducing salt build up.

It is another object of the invention to provide a horticultural growing medium having a homogeneous horticultural foam material which is sterile.

It is yet another object of the invention to provide a horticultural growing medium having a neutral pH which exhibits uniform hydrology.

It is still another object of the invention to provide a horticultural growing medium which can be economically fabricated to fit a wide variety of tray sizes.

It is another object of the invention to provide a horticultural growing medium which is a highly porous foam which maintains a 60 to 40 air to water ratio.

It is still another object to provide a horticultural growing medium which has high permeability and wettability necessary for greenhouse use.

It is yet another object of the invention to provide a horticultural growing medium which directs 90% of all water and nutrients to the plant and retains hydration.

It is still another object of the invention to provide a horticultural growing medium having a fabricated structure for exact placement of plant materials or seeds.

It is another object of the invention to provide a horticultural growing medium having a hole punched at a designated depth or a star cut that can be made narrow or wide.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a perspective view of seeding plugs made from medium of the present invention;

FIG. 2 is a perspective view of a single block of inventive material with a central bore cut therein;

FIG. 3 is a perspective view of the single block of invention material with a central star cut;

FIG. 4 is a perspective view of a single block of inventive material with a slit cut; and

FIG. 5 is a perspective view of a sheet of the inventive material with seeds adhesively applied thereto.

### DETAILED DESCRIPTION OF THE INVENTION

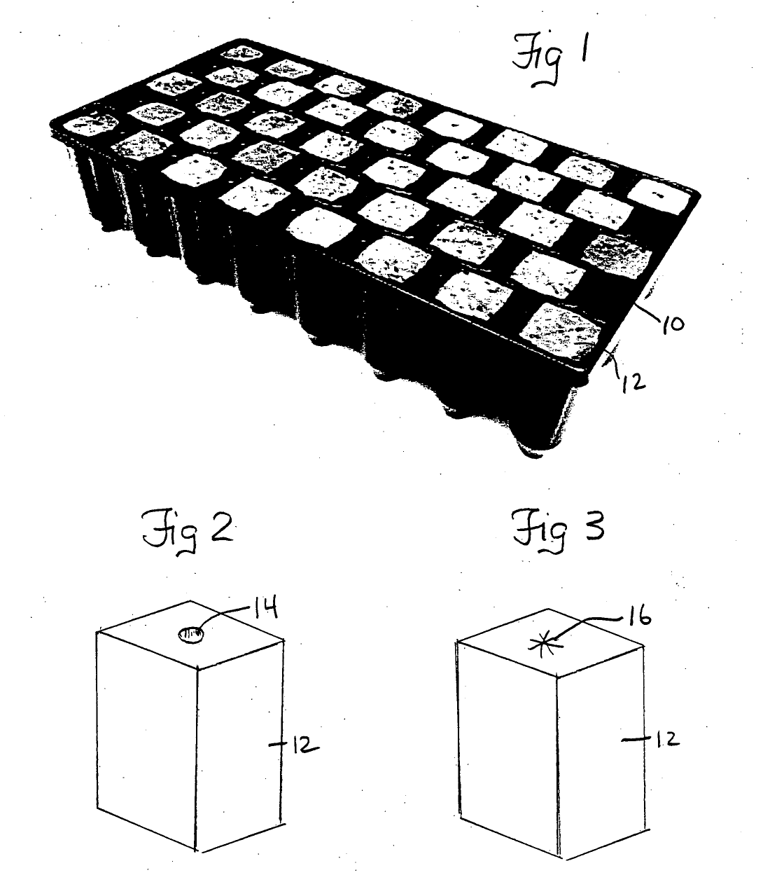

The preferred embodiment and best mode of the invention is shown in FIGS. 1 through 5.

As previously mentioned, the present invention is directed toward a growing medium for horticultural purposes. The growing medium comprises an aromatic polyisocyanate polymer diphenylmethane diisocyanate (MDI) flexible foam material using no filler material.

The polyisocyanate used in the foam material is an aromatic polyisocyanate which includes aromatic diisocyanates having 6 to 16 carbon atoms (excluding those contained in NCO groups; this applies to the polyisocyanates mentioned below), aromatic triisocyanates having 6 to 20 carbon atoms and crude products of these isocyanates, etc. Examples of aromatic polyisocyanate include 1,3- and 1,4-phenylene diisocyanates, 2,4- and/or 2,6-tolylene diisocyanates (TDI), crude TDI and 2,4′- and/or 4,4′-diphenylmethane diisocyanate (MDI) as well as crude MDI.

The preferred material which is used as the foam material in the invention is one or more of 2,2′-, 2,4′- and 4,4′-diphenylmethane diisocyanate (MDI), crude MDI, products of crude diaminodiphenyl methane where the crude diaminodiphenyl methane is a polymeric MDI or a mixture of the same; or is a mixture of diaminodiphenyl methane and a small amount (e.g., 5 to 20 mass %) of a polyamine having three or more functional groups; polyallyl polyisocyanate (PAPI), etc.

Such material is readily obtained in the market place and examples of same for purposes of showing commercial availability but which should not be construed as limiting are: BASF M-20S, and Rubinate 1680, Rubinate 1790, Rubinate 7302, Rubinate 7400, Rubinate 8700, Rubinate 9410 and Suprasec DNR all of which are available from ICI Americas.

The material is foamed in a conventional manner with a blowing agent such as carboxylic acids and anhydrides. It is important that no filler material is added to the foamed material and the material is substantially sterile with a neutral pH ranging from 6.8 to 7.8. The term substantially sterile is used in a horticultural sense and not as a medical term meaning the mateiral is free from plant disease, microbes, fungus, insects, disease, algae and animal life.

The material has a pore size with total porosity ranging from 85% to 95%, preferably from 90% to 92% with an air space ranging from 25 to 35%, preferably about 30%. Air space is the percent volume of a component which is filled with air after the material is saturated and allowed to drain. It is the minimum amount of air the material will have and is effected by the container height in reverse fashion to the container capacity; i.e., the taller the container, the more drainage and therefore more air space. For a given density and moisture content, Total Porosity+Container Capacity+Air Space. The present invention has a density of 1.00 to 3.00 preferably about 1.35 pounds per cubic foot and tensile strength ranging from 7.5 to 9.5, preferably at 8.0 psi per minute. The tear strength ranges from 0.18 to 0.22, preferably 0.2. Total porosity is the percent by volume of the foam that is comprised of pores. This is the volume fraction which provides the water and aeration in the foam material. The total porosity+the percent solids=100%. At least 40% to 60%, preferably about 50% of the foam material volume of the material contains pores ranging in size between 10 and 200 microns, preferably from about 40 to about 90 microns. These pores sizes are defined as mesopores which are responsible for water retention.

The micropore fraction (0.2 to 10 microns) of the foam material may range from 15% to 25% by foam volume, and preferably is held constant at about 20%. Micropores are responsible for water reserve and consist of open and closed pore cubic inch of foam.

The macropore fraction of the foam material ranges from 25% to 35%, preferably about 30% of the foam volume and contains pores ranging in size between 300-800 microns. These macropores are responsible for drainage and aeration.

The material has a low cation exchange capacity (C.E.C.) ranging from about 1.0 to about 1.5 milliequivalents Meq/100 g. of material, on a weight basis, and preferably has a C.E.C. of about 1.25 which allows for proportional fertilizer to growth of the plant when fertilizer is added to water and poured into the foam material. The low cation exchange capacity allows for nutrient availability and alleviates concerns of salt accumulation thus providing for fast and good root development. The foam block when planted in the soil allows the roots to reach outward from the foam block and not be root bound as the soil has a significantly higher C.E.C. Furthermore, the foam material has a stabilized pH ranging from 6.8 to 7.8. The above noted foam material product has superior rooting capabilities with a faster tooting time and root mass size.

The foam material releases 99% of the water back to the plant and is substantially sterile so that there is no food value to support microbial growth. Thus the percent volume of the foam material which contains water which is unavailable to the plant is about 1%. This is also called the permanent wilting percentage which is defined as the amount of water remaining a 1.5 Mpa (approximately −15 atmospheres). This property is a measure of the efficiency of the foam material to provide water to the plant. Therefore using the inventive foam material, plants grown in the medium can be transplanted world wide without agricultural disease problems with maximum water retention for plant usage. Furthermore, the material is frangible, photodegradable and biodegradable allowing it to break down naturally so that it does not present environmental problems.

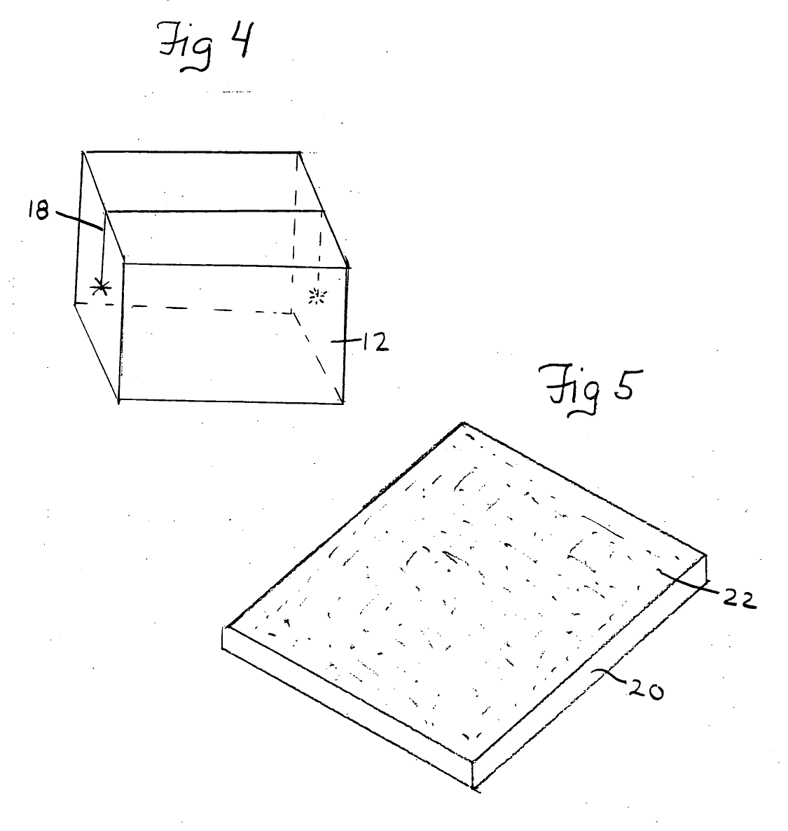

The foam growing material is molded in flats containing a series of growing medium blocks which are then cut into shaped individual blocks 12 and placed into a tray 10 as seen in FIG. 1. While the material may be molded, because of the heat required during curing, the same deforms thin plastic trays. A cavity may be formed or cut into the growing medium material to enhance ease of seedling or plant cutting in the growing medium block as shown in FIGS. 2-4. This cavity can take the form of a bore 14, a star shaped cut 16 or a horizontal slit 18. If desired, the foam material can be in sheet form 20 as seen in FIG. 5 for grass development. In such a usage, the seeds 22 are adhesively secured to the surface of the growth medium or are deposited within the body of the foam material.

The “flat” or tray 10 which contains a plurality of compartments, or may be of any desired shape or configuration.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present inventions defined by the following claims.

1. A horticultural growing medium comprising:
a flexible diphenylmethane diisocyanate foam material without filler material having a cation exchange capacity ranging from about 1.0 to about 1.5,
said horticultural growing medium being capable of supporting plant growth.

2. The horticultural growing medium of claim 1, wherein said cation exchange capacity is about 1.25.

3. The horticultural growing medium of claim 1, wherein said diphenylmethane diisocyanate foam material is taken from a group consisting of polymeric diphenylmethane diisocyanate, crude diphenylmethane diisocyanate, 4,4′-, 2,4′-, 2,2′-diphenylmethane diisocyanate.

4. The horticultural growing medium of claim 1, wherein said diphenylmethane diisocyanate foam material is polymeric diphenylmethane diisocyanate.

5. The horticultural growing medium of claim 1, wherein said diphenylmethane diisocyanate foam material is one or a mixture of 2,2′-, 2,4′- and 4,4′-diphenylmethane diisocyanate (MDI), polymeric MDI, crude MDI, namely, products of crude diaminodiphenyl methane or a mixture of the same

6. The horticultural growing medium of claim 1, wherein said foam material has a neutral pH ranging from 6.8 to 7.8.

7. The horticultural growing medium of claim 1, wherein said foam material is highly porous and maintains a 60 to 40 air to water ratio.

8. The horticultural growing medium of claim 1, wherein said foam material has at least 50% of its pores by foam volume ranging in size between 10 and 200 microns.

9. The horticultural growing medium of claim 1, wherein said foam material has about 50% of its pores by foam volume ranging in size from 40 to about 90 microns.

10. The horticultural growing medium of claim 1, wherein said foam material has pores ranging from 20% to about 25% by foam volume which range in size between about 0.2 microns to about 10 microns.

11. The horticultural growing medium of claim 1, wherein said foam material has pores ranging from about 25% to about 35% by foam volume which range in size between about 300 microns to about 800 microns.

12. The horticultural growing medium of claim 1, wherein said foam material is substantially sterile.

13. The horticultural growing medium of claim 1, wherein said foam material has pores of about 30% by foam volume which range in size between about 300 microns to about 800 microns.

14. The horticultural growing medium of claim 1 wherein said foam material has a total porosity ranging from 85% to 95%.

15. The horticultural growing medium of claim 1 wherein said foam material has a total porosity of about 90% to 92%.

16. A horticultural growing medium comprising:
a sterile hydrophilic unfilled foam material made of diphenylmethane diisocyanate having at least 50% of its pores by foam volume ranging in size between 10 and 200 microns with a cation exchange capacity ranging from about 1.0 to about 1.5, said foam material having a total porosity ranging from about 85% to about 95%;
said horticultural growing medium being capable of supporting plant growth.

17. The horticultural growing medium of claim 16, wherein said foam material is at least one diphenylmethane diisocyanate taken from a group consisting of crude, polymeric, 4,4′-, 2,4′- and 2,2′-diphenylmethane diisocyanate.

18. The horticultural growing medium of claim 16, wherein said foam material is polymeric diphenylmethane diisocyanate.

19. The horticultural growing medium of claim 16, wherein said foam material is one or more of 2,2′-, 2,4′- and 4,4′-diphenylmethane diisocyanate (MDI), crude MDI, polymeric MDI or a mixture of the same.

20. A horticultural growing medium comprising:
a substantially sterile unfilled foam material made of polymeric diphenylmethane diisocyanate taken from a group consisting of one or more of 2,2′-, 2,4′- and 4,4′-diphenylmethane diisocyanate (MDI), crude MDI, products of crude diaminodiphenyl methane including polymeric MDI or a mixture of the same, having at least 50 of its pores ranging in size between 10 and 200 microns with a cation exchange capacity ranging from about 1.0 to about 1.5, with a total porosity ranging from about 90% to about 92%,
said horticultural growing medium being capable of supporting plant growth.

21. A horticultural growing medium as claimed in claim 20 wherein said foam material is a sheet with seeds secured thereto.

22. A horticultural growing medium as claimed in claim 20 wherein said foam material is a shaped block with an aperture cut therein.

23. A horticultural growing medium as claimed in claim 20 wherein said cation exchange capacity is about 1.0.

24. (canceled)

25. A horticultural growing medium comprising:
a hydrophilic, substantially sterile diphenylmethane diisocyanate foam material without filler material taken from a group consisting of polymeric diphenylmethane diisocyanate, crude diphenylmethane diisocyanate, 4,4′-, 2,4′-, 2,2′-diphenylmethane diisocyanate and having a neutral pH ranging from 6.8 to 7.8, said material having a cation exchange capacity ranging from about 1.0 to about 1.5,
said horticultural growing medium being capable of supporting plant growth.

26. A horticultural growing medium comprising:
a hydrophilic flexible sterile foam material made of diphenylmethane diisocyanate said foam material being taken from a group consisting of crude, polymeric, 4,4′-, 2,4′- and 2,2′-diphenylmethane diisocyanate having at least 50% of its pores by foam volume ranging in size between 10 and 200 microns with a cation exchange capacity ranging from about 1.0 to about 1.5, said foam material having a total porosity ranging from about 85% to about 95%;
said horticultural growing medium being capable of supporting plant growth.
